(19) United States
(12) Patent Application Publication
(10) Pub. No.: US 2025/0129286 A1
(43) Pub. Date: Apr. 24, 2025

(54) SCALE CONTROL IN PRODUCTION FLUIDS

(71) Applicant: Saudi Arabian Oil Company, Dhahran (SA)

(72) Inventors: Hamad Alsaiari, Al-Khobar (SA); Sarah A. Aqeel, Dhahran (SA); Laila Alabdrabalnabi, Sayhat (SA); Christian Canto Maya, Dhahran (SA)

(21) Appl. No.: 18/490,305

(22) Filed: Oct. 19, 2023

(51) Int. Cl. C09K 8/528; E21B 37/06

(52) U.S. Cl. CPC C09K 8/528; E21B 37/06

(57) ABSTRACT

Methods for reducing scale deposition are provided. An exemplary method for reducing scale in an oilfield facility includes contacting a production surface with a production fluid including a bacteria, the bacteria present in the production fluid in a concentration of at least about 20/mL.

### TECHNICAL FIELD

The present disclosure is directed to controlling scale in oilfield production fluids.

### BACKGROUND

Inorganic scale has been a persistent problem in many oil and gas production systems. Scale can precipitate in bulk solution or deposit onto surfaces within subterranean formations, wellbore production tubing, and topside facilities. Such precipitates and deposits can restrict hydrocarbon flow, damage equipment, induce localized corrosion, and interfere with oil-water separation. For example, scale has been known to interfere with, interrupt, or even stop oil production.

One approach to control scale formation has been to inject a mixture of a scale inhibitor and a corrosion inhibitor into a subterraneous formation, either continuously through chemical injection lines, or in batches through production tubing. If chemical injection lines are unavailable, batch injection, also referred to as squeeze treatment, must be utilized. However, there is a risk of subterranean formation damage when a large volume of inhibitors is injected into the formation. Also, there is also a risk of incompatibility between the conventional scale inhibitors and corrosion inhibitors when used in such applications.

Thus, there remains a need for improved processes for controlling scale deposition in oilfield facilities.

### SUMMARY

Provided in the present disclosure is a method for reducing scale in an oilfield facility. The method includes contacting a production surface with a production fluid including a bacteria, and a concentration of the bacteria in the production fluid is at least about 20/mL.

In some embodiments, the concentration of the bacteria is about 20/mL to about 1,000/mL. In some embodiments, the concentration of the bacteria is about 100/mL to about 500/mL.

In some embodiments, the bacteria includes a cell well having a net negative charge in the production fluid. In some embodiments, the bacteria includes E. coli, Pseudomonas, Xanthanomonas, Achromobacter, Alcaligenes, or any combination thereof.

In some embodiments, the production fluid includes water from a subterranean formation. In some embodiments, the production surface includes stainless steel. In some embodiments, the production surface includes an inner surface of production tubing. In some embodiments, the production tubing includes downhole completion tubing.

In some embodiments, the method includes injecting the bacteria into a subterranean formation to form the production fluid, and contacting the production surface includes transporting the production fluid from the subterranean formation through the production tubing. In some embodiments, injecting the bacteria includes pumping the bacteria into the subterranean formation through the production tubing. In some embodiments, the production surface includes an inner surface of a water treatment facility.

In some embodiments, the production fluid includes one or more cations selected from Na⁺, K⁺, Ca²⁺, Ba²⁺, Sr²⁺, Fe²⁺, and Mg²⁺. In some embodiments, at least a portion of the one or more cations is bound to a cell wall of the bacteria.

In some embodiments, the production fluid includes no more than 50 ppm of a total amount of polymers including acrylic acid monomer units, polymers including maleic acid monomer units, and phosphonic acids. In some embodiments, the production fluid is substantially free from polymers including acrylic acid monomer units, polymers including maleic acid monomer units, and phosphonic acids.

Also provided in the present disclosure is a method for forming and transporting a production fluid. The method includes injecting a bacteria into a subterranean formation including water to form the production fluid, and then transporting the production fluid through production tubing. The production fluid includes the bacteria and water from the formation, and a concentration of the bacteria in the production fluid is at least about 20/mL.

In some embodiments of the method, the bacteria includes E. coli, Pseudomonas, Xanthanomonas, Achromobacter, Alcaligenes, or any combination thereof. In some embodiments of the method, injecting the bacteria includes pumping a dose of the bacteria into the subterranean formation through the production tubing.

In some embodiments of the method, the dose is substantially free from polymers including acrylic acid monomer units, polymers including maleic acid monomer units, and phosphonic acids. In some embodiments of the method, the dose includes water and the bacteria, and a concentration of the bacteria in the dose is at least about 1,000/mL.

### BRIEF DESCRIPTION OF DRAWINGS

FIG. 1 is a schematic illustration of complex including positive scale-forming cations bound to a net-negatively charged bacterial cell wall.

FIG. 2 is a process flow diagram of a method of reducing scale in an oilfield facility.

FIG. 3 is a process flow diagram of a method of reducing scale in an oilfield facility.

FIG. 4 is a graph showing transmittance over time for cation-containing solutions.

### DETAILED DESCRIPTION

The present disclosure relates to methods for reducing scale deposition. In particular, the methods of the present disclosure can reduce scale precipitation and deposition onto production surfaces in an oilfield facility, such as those of production tubing and water treatment facilities. Production fluids formed and transported according to methods of the present disclosure can exhibit limited scale precipitation and reposition within production tubing.

### Scale Control Methods

Provided in the present disclosure are methods for reducing scale in an oilfield facility. The method includes contacting a production surface with a production fluid including a bacteria, the bacteria present in the production fluid in a concentration of at least about 20/mL.

In some embodiments, the concentration of the bacteria is at least about 20/mL, at least about 50/mL, or at least about 100/mL. In some embodiments, the concentration of the bacteria is about 20/mL to about 2,000/mL, for example, about 20/mL to about 1,000/mL, about 20/mL to about 750/mL, about 20/mL to about 500/mL, about 50/mL to about 2,000/mL, about 50/mL to about 1,000/mL, about 50/mL to about 750/mL, about 50/mL to about 500/mL, about 100/mL to about 2,000/mL, about 100/mL to about 1,000/mL, about 100/mL to about 750/mL, or about 100/mL to about 500/mL. In some embodiments, the concentration of the bacteria is about 100/mL, about 150/mL, about 200/mL, about 250/mL, about 300/mL, about 350/mL, about 400/mL, about 450/mL, or about 500/mL.

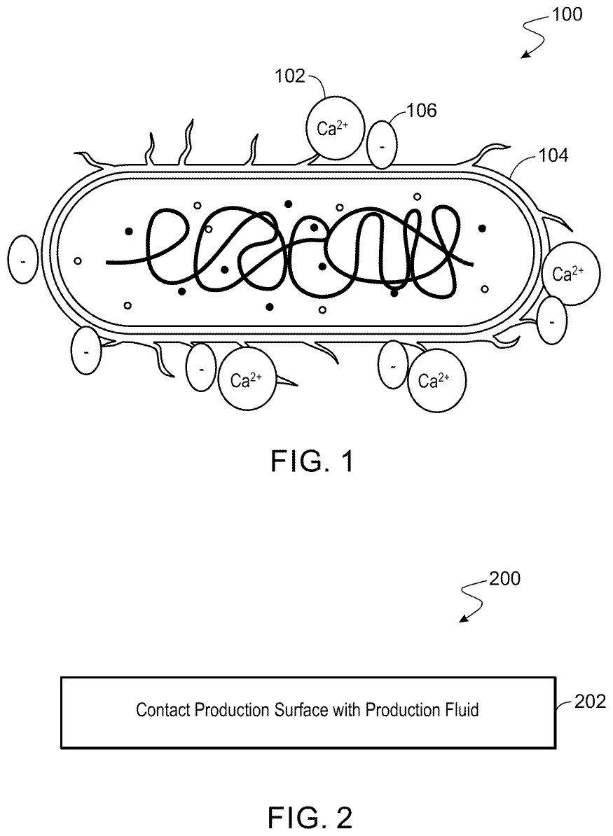

In some embodiments, the bacteria includes a cell wall having a net negative charge in the production fluid. For example, in some embodiments, the production fluid has a pH of about 4.6 to about 8, and the bacteria includes a cell wall having a net negative charge in the production fluid. For example, FIG. 1 is a schematic illustration of a complex 100 including positive scale-forming cations 102 bound to a bacterial cell wall 104 bearing negatively charged groups 106. In some examples, carboxylate groups, phosphate groups, or both can contribute to the net negative charge of the bacterial cell wall. In some embodiments, the bacteria is non-corrosive. Examples of bacteria include E. coli, Pseudomonas, Xanthanomonas, Achromobacter, and Alcaligenes. In some embodiments, the bacteria includes E. coli.

In some embodiments, the production surface includes stainless steel. For example, the production surface may be substantially stainless steel. The production surface may make up an inner surface of tubing, for example, containing stainless steel. The production surface contacted with the production fluid may be production tubing such as downhole completion tubing, coiled tubing, and the like. The production surface may make up an inner surface of a water treatment facility, for example, an inner surface of tubing of a water treatment facility.

In some embodiments, the method further includes injecting the bacteria into a subterranean formation to form the production fluid, which can be transported from the formation through production tubing of the present disclosure, such as stainless steel downhole completion tubing. The bacteria can be injected through chemical injection lines or through the production tubing. In some embodiments, the production fluid can be transported through tubing of a water treatment facility. In some embodiments, the method further includes injecting the bacteria into tubing including treated water, for example, tubing of a water treatment facility or downstream from a water treatment facility, to form the production fluid.

In some embodiments, injecting the bacteria into the subterranean formation includes pumping a dose of the bacteria into the subterranean formation through production tubing, such as downhole completion tubing, as a batch. For example, the dose can include water and the bacteria, and a concentration of the bacteria in the dose can be at least about 1,000/mL. In some embodiments, the dose includes at least about 2,000/mL, at least about 3,000/mL, at least about 4,000/mL, at least about 5,000/mL of the bacteria, at least 10,000/mL of the bacteria, at least 50,000/mL of the bacteria, or at least 100,000/mL of the bacteria.

In some embodiments, the dose contains 5 wt. % or less, 2.5 wt. % or less, 1 wt. % or less, or 0.5 wt. % or less of a total amount of polymers containing acrylic acid monomer units, polymers containing maleic acid monomer units, and phosphonic acids. For example, the dose is substantially free from polymers containing acrylic acid monomer units, polymers containing maleic acid monomer units, and phosphonic acids.

Injection of the dose, for example through production tubing such as downhole completion tubing, can form a production fluid of the present disclosure, for example, including bacteria of the present disclosure in a concentration of at least about 20/mL, at least about 50/mL, at least about 100/mL, about 20/mL to about 2,000/mL, for example, about 20/mL to about 1,000/mL, about 20/mL to about 750/mL, about 20/mL to about 500/mL, about 50/mL to about 2,000/mL, about 50/mL to about 1,000/mL, about 50/mL to about 750/mL, about 50/mL to about 500/mL, about 100/mL to about 2,000/mL, about 100/mL to about 1,000/mL, about 100/mL to about 750/mL, about 100/mL to about 500/mL, about 100/mL, about 150/mL, about 200/mL, about 250/mL, about 300/mL, about 350/mL, about 400/mL, about 450/mL, or about 500/mL.

In some embodiments, the production fluid contains water from a subterranean formation. In some embodiments, the production fluid contains treated water, for example from treatment of water from a subterranean formation in a water treatment facility. In some embodiments, the production fluid includes a multiphase mixture. In some embodiments, the production fluid contains one or more cations selected from Na⁺, K⁺, Ca²⁺, Ba²⁺, Sr²⁺, Fe²⁺, and Mg²⁺. In some embodiments, at least a portion of the one or more cations is bound to a cell wall of the bacteria.

In some embodiments, the production fluid contains no more than about 50 ppm, or no more than about 40 ppm, or no more than about 30 ppm, or no more than about 20 ppm, or no more than about 10 ppm, or no more than about 5 ppm of a total amount of polymers containing acrylic acid monomer units, polymers containing maleic acid monomer units, and phosphonic acids. For example, the production fluid is substantially free from polymers containing monomer units, polymers containing maleic acid monomer units, and phosphonic acids.

### Formation-Transportation Methods

Also provided in the present disclosure are methods for forming and transporting a production fluid. The method includes injecting a bacteria of the present disclosure into a subterranean formation containing water to form the production fluid, and then transporting the production fluid through production tubing. The production fluid includes the bacteria and water from the formation, and the concentration of the bacteria in the production fluid is at least about 20/mL. In some embodiments, the bacteria includes E. coli.

In some embodiments of the formation-transportation methods, injecting bacteria into the subterranean formation includes pumping a dose of the bacteria into the subterranean formation through the production tubing. For example, the dose is injected through downhole completion tubing, such as stainless steel downhole completion tubing.

In some embodiments of the formation-transportation methods, a dose of the present disclosure is injected into the subterranean formation through the production tubing, for example, as a batch. In some embodiments, the dose includes water and the bacteria, and a concentration of the bacteria in the dose is at least about 1,000/mL. In some embodiments, the dose includes at least about 2,000/mL, at least about 3,000/mL, at least about 4,000/mL, at least about 5,000/mL of the bacteria, at least 10,000/mL of the bacteria, at least 50,000/mL of the bacteria, or at least 100,000/mL of the bacteria.

In some embodiments, the dose contains 5 wt. % or less, 2.5 wt. % or less, 1 wt. % or less, or 0.5 wt. % or less of a total amount of polymers containing acrylic acid monomer units, polymers containing maleic acid monomer units, and phosphonic acids.

In some embodiments of the formation-transportation methods, injecting a dose, such as a dose of the present disclosure, forms a production fluid of the present disclosure. For example, the concentration of the bacteria in the production fluid formed by injection of the dose through the production tubing is at least about 20/mL, at least about 50/mL, at least about 100/mL, about 20/mL to about 2,000/mL, for example, about 20/mL to about 1,000/mL, about 20/mL to about 750/mL, about 20/mL to about 500/mL, about 50/mL to about 2,000/mL, about 50/mL to about 1,000/mL, about 50/mL to about 750/mL, about 50/mL to about 500/mL, about 100/mL to about 2,000/mL, about 100/mL to about 1,000/mL, about 100/mL to about 750/mL, about 100/mL to about 500/mL, about 100/mL, about 150/mL, about 200/mL, about 250/mL, about 300/mL, about 350/mL, about 400/mL, about 450/mL, or about 500/mL.

FIG. 2 is a process flow diagram of a method 200 of reducing scale in an oilfield facility. The method includes, at block 202, contacting a production surface with a production fluid containing a bacteria, present in a concentration of at least about 20/mL.

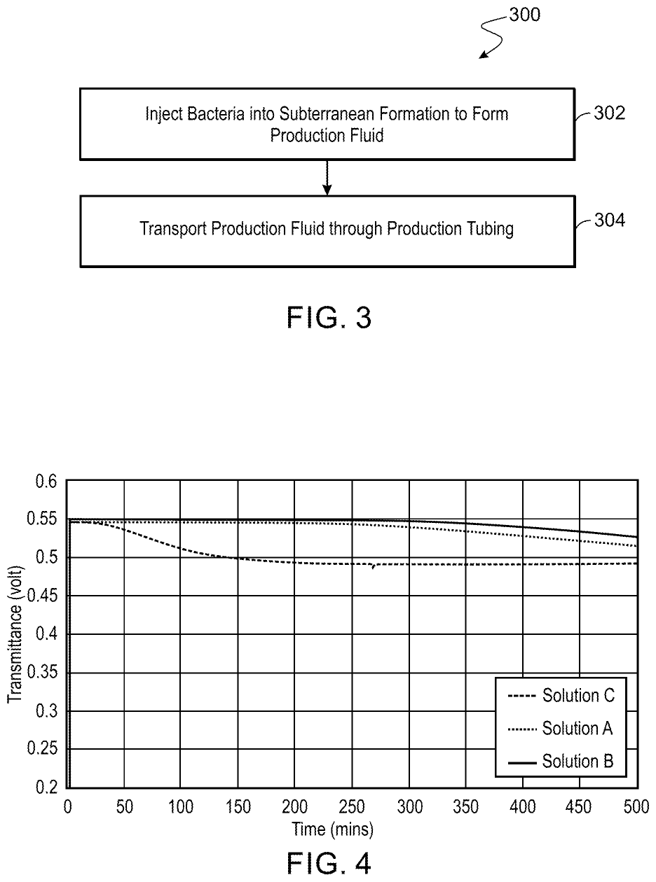

FIG. 3 is a process flow diagram of a method 300 of forming and transporting a production fluid. The method starts at block 302 with the injection of a bacteria into a subterranean formation containing water to form a production fluid containing water from the formation and the bacteria, present in a concentration of at least about 20/mL. At block 304, the production fluid is transported through production tubing.

### Examples

### Example 1—CaCO₃ Inhibition

Tests were performed to evaluate the effect of E. coli on calcium carbonate bulk precipitation. A stock solution of 1% of sodium chloride (NaCl) was prepared by dissolving sodium chloride salt (Sigma-Aldrich, S7653-1 KG) in deionized water at room temperature. Likewise, a stock solution of 5000 ppm calcium ions (Ca²⁺), and 5000 ppm bicarbonate ions (HCO₃⁻) were separately prepared by mixing calcium chloride dehydrated (CaCl₂·2H₂O), and sodium bicarbonate (NaHCO₃) with a deionized water at room temperature. All of the stock solutions were sterilized in autoclave for one hour.

The solution supersaturation was calculated in term of saturation index (SI) using SSP software developed by Rice University (Kan et al. 2015, Dai et al. 2014).

The microbial growth medium was prepared by adding 20 gram of Luria-Bertani (LB) broth powder (Sigma-Aldrich, L3022-1 KG) in 1 litter of deionized water. The LB broth powder contained tryptone (10 g/L), yeast extract (5 g/L), and NaCl (5 g/L). The microbial growth medium was sterilized by autoclaving the mixed LB broth with deionized water for one hour. The LB broth was cooled down at room temperature. Then, Escherichia coli (ATCC 25922) were inoculated into LB broth and incubated in New Brunswick Scientific incubator shaker Innova 40 at 37° C. for two days. To obtain 103/ml of E. coli, the prepared E. coli culture was centrifuged in Eppendorf Centrifuge 5417R at 1100 rpm for 15 minutes. Then the pellet of E. coli was transferred to 0.85% of sodium chloride and diluted to 103/ml of E. coli.

For blank experiment (absence of bacteri), Solution C was prepared by adding 10 ml of the stock solution of 5000 ppm calcium ions, 8 ml of the stock solution of 5000 ppm bicarbonate ions, and 50 ml of 1.0% of sodium chloride solution. Solutions A and B were prepared by adding 10 ml of the stock solution of 5000 ppm calcium ions, 8 ml of the stock solution of 5000 ppm bicarbonate ions, 50 ml of 1.0% of sodium chloride stock solution, and about 103/ml of E. coli. Then, a green laser was turned on immediately after mixing. The laser beam was passed through the solution and data were recorded in term of transmittance vs. time. The final concentrations of the constituent ions were selected to have a controllable precipitation of calcium carbonate. As shown in FIG. 4, the transmittance of solutions A and B remained higher over time as compared to solution C, indicating that the bacteria inhibited scale formation.

### Definitions

In the present disclosure, the terms “a,” “an,” and “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed in the present disclosure, and not otherwise defined, is for the purpose of description only and not of limitation. Any use of section headings is intended to aid reading of the document and is not to be interpreted as limiting; information that is relevant to a section heading may occur within or outside of that particular section.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (for example, 1%, 2%, 3%, and 4%) and the sub-ranges (for example, 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

The term “about” as used in the present disclosure can allow for a degree of variability in a value or range, for example, within 10%, within 5%, or within 1% of a stated value or of a stated limit of a range.

In the methods described in the present disclosure, the acts can be carried out in any order, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

As used in the present disclosure, the term “downhole” refers to under the surface of the earth, such as a location within or fluidly connected to a wellbore.

As used in the present disclosure, the term “subterranean formation” refers to any material under the surface of the earth, including under the surface of the bottom of the ocean. For example, a subterranean formation or material can be any section of a wellbore and any section of a subterranean petroleum- or water-producing formation or region in fluid contact with the wellbore. Placing a material in a subterranean formation can include contacting the material with any section of a wellbore or with any subterranean region that is in fluid contact with the wellbore. Subterranean materials can include any materials placed into the wellbore such as cement, drill shafts, liners, tubing, casing, or screens; placing a material in a subterranean formation can include contacting with such subterranean materials. In some examples, a subterranean formation or material can be any below-ground region that can produce liquid or gaseous petroleum materials, water, or any section below-ground that is in fluid contact with liquid or gaseous petroleum materials or water. A subterranean formation can be an oil well.

As used in the present disclosure, the term “scale” can be used interchangeably with “mineral scale” and “inorganic scale” and refers to insoluble crystals that can precipitate from production fluid and can deposit onto surfaces of oil processing systems.

As used in the present disclosure, the term “production fluid” refers to fluid that is recovered as part of a subterranean oil or gas extraction operation. A production fluid can include water, hydrocarbons, or both.

As used in the present disclosure, the term “production surface” refers to any surface of an oilfield facility that can contact a production fluid. Production surfaces can include for example, an inner surface of production tubing, tubing in a water treatment facility, etc.

As used in the present disclosure, the term “production tubing” refers to tubing that can be used to transport a production fluid as part of a subterranean oil or gas extraction operation. Production tubing can be located downhole, or can be located above the surface of the earth.

As used in the present disclosure, the term “downhole completion tubing” refers to production tubing that can be used to transport a production fluid from a subterranean formation to the surface of the earth.

### OTHER EMBODIMENTS

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

1. A method for reducing scale in an oilfield facility, the method comprising contacting a production surface with a production fluid comprising a bacteria, wherein a concentration of the bacteria in the production fluid is at least about 20/mL.

2. The method of claim 1, wherein the concentration of the bacteria is about 20/mL to about 1,000/mL.

3. The method of claim 1, wherein the concentration of the bacteria is about 100/mL to about 500/mL.

4. The method of claim 1, wherein the bacteria comprises a cell well having a net negative charge in the production fluid.

5. The method of claim 1, wherein the bacteria comprises E. coli, Pseudomonas, Xanthanomonas, Achromobacter, Alcaligenes, or any combination thereof.

6. The method of claim 1, wherein the production fluid comprises water from a subterranean formation.

7. The method of claim 1, wherein the production surface comprises stainless steel.

8. The method of claim 1, wherein the production surface comprises an inner surface of production tubing.

9. The method of claim 8, wherein the production tubing comprises downhole completion tubing.

10. The method of claim 8, further comprising injecting the bacteria into a subterranean formation to form the production fluid, wherein contacting the production surface comprises transporting the production fluid from the subterranean formation through the production tubing.

11. The method of claim 10, wherein injecting the bacteria comprises pumping the bacteria into the subterranean formation through the production tubing.

12. The method of claim 1, wherein the production surface comprises an inner surface of a water treatment facility.

13. The method of claim 1, wherein the production fluid comprises one or more cations selected from Na⁺, K⁺, Ca²⁺, Ba²⁺, Sr²⁺, Fe²⁺, and Mg²⁺.

14. The method of claim 13, wherein at least a portion of the one or more cations is bound to a cell wall of the bacteria.

15. The method of claim 1, wherein the production fluid comprises no more than 50 ppm of a total amount of polymers comprising acrylic acid monomer units, polymers comprising maleic acid monomer units, and phosphonic acids.

16. The method of claim 1, wherein the production fluid is substantially free from polymers comprising acrylic acid monomer units, polymers comprising maleic acid monomer units, and phosphonic acids.

17. A method for forming and transporting a production fluid, the method comprising:
injecting a bacteria into a subterranean formation comprising water to form the production fluid; and then
transporting the production fluid through production tubing;
wherein the production fluid comprises the bacteria and water from the formation, and a concentration of the bacteria in the production fluid is at least about 20/mL.

18. The method of claim 17, wherein the bacteria comprises E. coli, Pseudomonas, Xanthanomonas, Achromobacter, Alcaligenes, or any combination thereof.

19. The method of claim 17, wherein injecting the bacteria comprises pumping a dose of the bacteria into the subterranean formation through the production tubing.

20. The method of claim 19, wherein the dose is substantially free from polymers comprising acrylic acid monomer units, polymers comprising maleic acid monomer units, and phosphonic acids.

21. The method of claim 19, wherein the dose comprises water and the bacteria, and a concentration of the bacteria in the dose is at least about 1,000/mL.
